(19) United States
(12) Patent Application Publication
(10) Pub. No.: US 2019/0204681 A1
(43) Pub. Date: Jul. 4, 2019

(54) ELECTRONIC PAPER, DISPLAY METHOD THEREOF, AND DISPLAY DEVICE

(71) Applicants: BOE Technology Group Co., Ltd., Beijing (CN); Chengdu BOE Optoelectronics Technology Co., Ltd., Chengdu (CN)

(72) Inventors: Gang Zhou, Beijing (CN); Xiaofei Yang, Beijing (CN)

(21) Appl. No.: 16/054,281

(22) Filed: Aug. 3, 2018

(30) Foreign Application Priority Data
Jan. 2, 2018 (CN) 201810003167.1

(51) Int. Cl. G02F 1/1335; G02F 1/1333; G02F 1/133

(52) U.S. Cl. CPC G02F 1/133602; G02F 1/133512; G02F 2201/123; G02F 1/13306; G02F 2201/121; G02F 1/133345

(57) ABSTRACT

The present disclosure provides an electronic paper, a display method thereof and a display device. The electronic paper of the present disclosure includes an upper substrate, a lower substrate, a pixel electrode, a common electrode, and charged particles. The upper substrate and the lower substrate are disposed opposite to each other. The electronic paper further includes a backlight source disposed at a side of the lower substrate far away from the upper substrate. The pixel electrode is disposed at a side of the upper substrate close to the lower substrate. The common electrode is perpendicular to the lower substrate and is disposed between the upper substrate and the lower substrate.

### CROSS REFERENCE

This application is based upon and claims priority to Chinese Patent Application No. 201810003167.1, filed on Jan. 2, 2018, the entire contents thereof are incorporated herein by reference.

### TECHNICAL FIELD

The present disclosure relates to the technical field of image display, and particularly to an electronic paper, a display method thereof and a display device.

### BACKGROUND

Electronic paper is an electronic displayer like a paper sheet, and displays an image by utilizing electronic ink. The electronic ink is a liquid material consisted of numerous suspended microcapsules, and each of the microcapsules is consisted of a particle carrying positive charge and a particle carrying negative charge which have different colors. The electronic paper is provided with a pixel electrode and a common electrode, so that the particle carrying positive charge and the particle carrying negative charge can be moved in an electric field and finally be attached onto corresponding electrodes, so as to control different pixel locations to display different colors, and hence to control the electronic ink to present an image on the electronic paper.

In related art, the electronic paper has to rely on a reflection of light from external environment to display an image. A display effect of the electronic paper is dependent on a light intensity of ambient light. The electronic paper in an environment with relatively weaker light or in a dark environment may not be able to normally display an image, which affects a reading experience of users.

### SUMMARY

In some arrangements, the present disclosure provides an electronic paper, including an upper substrate, a lower substrate, a pixel electrode, a common electrode, and charged particles configured to constitute a displayed image. The upper substrate and the lower substrate are disposed opposite to each other. The electronic paper further includes a backlight source disposed at a side of the lower substrate far away from the upper substrate. The pixel electrode is disposed at a side of the upper substrate close to the lower substrate. The common electrode is perpendicular to the lower substrate and is disposed between the upper substrate and the lower substrate.

In some arrangements, the electronic paper further includes a black matrix layer disposed between the upper substrate and the pixel electrode. The common electrode is disposed between a black region of the black matrix layer and the lower substrate.

In some arrangements, the pixel electrode is disposed at a hollowed-out location of the black matrix layer, and each pixel electrode is connected with an independent voltage controlling unit.

In some arrangements, in a horizontal direction parallel to the lower substrate, the common electrode is corresponding to the black matrix layer and is distributed in a form of net between the black matrix layer and the lower substrate.

In some arrangements, the electronic paper includes a light source switch configured to control an on-off state of the backlight source and to adjust a brightness of backlight.

In some arrangements, the charged particle is filled between the pixel electrode and the lower substrate, and includes a combination of two types of colored, charged particles with different polarities and a same driving voltage, or a combination of at least two types of colored, charged particles with a same polarity and different driving voltages, or a combination of at least two types of colored, charged particles with different polarities and different driving voltages.

In some arrangements, the present disclosure provides a display method of an electronic paper by utilizing the electronic paper described herein, including applying a driving voltage on the pixel electrode, the driving voltage being configured to allow a corresponding charged particle to be attached onto the pixel electrode from the common electrode, and switching on the backlight source according to an on signal of the backlight source as received.

In some arrangements, switching on the backlight source according to an on signal of the backlight source as received includes detecting a light intensity of current environment by utilizing an optical sensor, sending an on signal to a light source switch of the backlight source upon the light intensity being smaller than a threshold, and switching on the backlight source by the light source switch.

In some arrangements, in the case where the charged particle includes two types of particles with different polarities, applying a driving voltage on the pixel electrode includes: calculating a voltage polarity of the pixel electrode in different regions of the electronic paper according to the displayed image, applying a corresponding positive voltage or negative voltage on the pixel electrode according to the voltage polarity, and applying a reference voltage on the common electrode.

In some arrangements, in the case where the charged particle includes colored charged particles with different polarities and multiple driving voltages, applying a driving voltage on the pixel electrode includes determining a driving strategy of the pixel electrode in different regions of the electronic paper according to an image color of the displayed image, the driving strategy being configured to allow charged particles with a specified color to be attached onto the pixel electrode by changing a voltage applying process of applying a polarity voltage on the pixel electrode, applying a driving voltage on a corresponding pixel electrode according to the driving strategy, and applying a reference voltage on the common electrode.

In some arrangements, the present disclosure provides a display device, the display device is provided with the electronic paper described herein.

### BRIEF DESCRIPTION OF THE DRAWINGS

After study of the following detailed description of illustrative arrangements, various other advantages and benefits will become apparent for those ordinary skilled in the art. The drawings are merely for the purpose of illustrating illustrative arrangements but not for limiting the present disclosure. Moreover, throughout the entire drawing, identical reference numerals are used to indicate identical parts. In the drawings:

FIG. 1 illustrates a structural view of a local section of an electronic paper provided by an arrangement of the present disclosure;

FIG. 2 illustrates a structural view of a local section of another electronic paper provided by an arrangement of the present disclosure;

FIG. 3 illustrates a structural view of a local section of another electronic paper provided by an arrangement of the present disclosure;

FIG. 4 illustrates a structural view of a local section of another electronic paper provided by an arrangement of the present disclosure;

FIG. 5 illustrates a structural view of a local section of another electronic paper provided by an arrangement of the present disclosure;

FIG. 6 illustrates a flow chart of a display method of an electronic paper provided by an arrangement of the present disclosure;

FIG. 7 illustrates a flow chart of another display method of an electronic paper provided by an arrangement of the present disclosure; and

FIG. 8 illustrates a flow chart of another display method of an electronic paper provided by an arrangement of the present disclosure.

### DETAILED DESCRIPTION

Hereinafter, specific arrangements, structures, features and technical effects of the electronic paper, the display method thereof and the display device provided by the present disclosure will be described in more details in conjunction with the drawings and illustrative arrangements. In the following description, various “an arrangement” or “the arrangement” is not always intended to indicate the same arrangement. Additionally, particular technical features or structures in one or more arrangements may be combined in any manner.

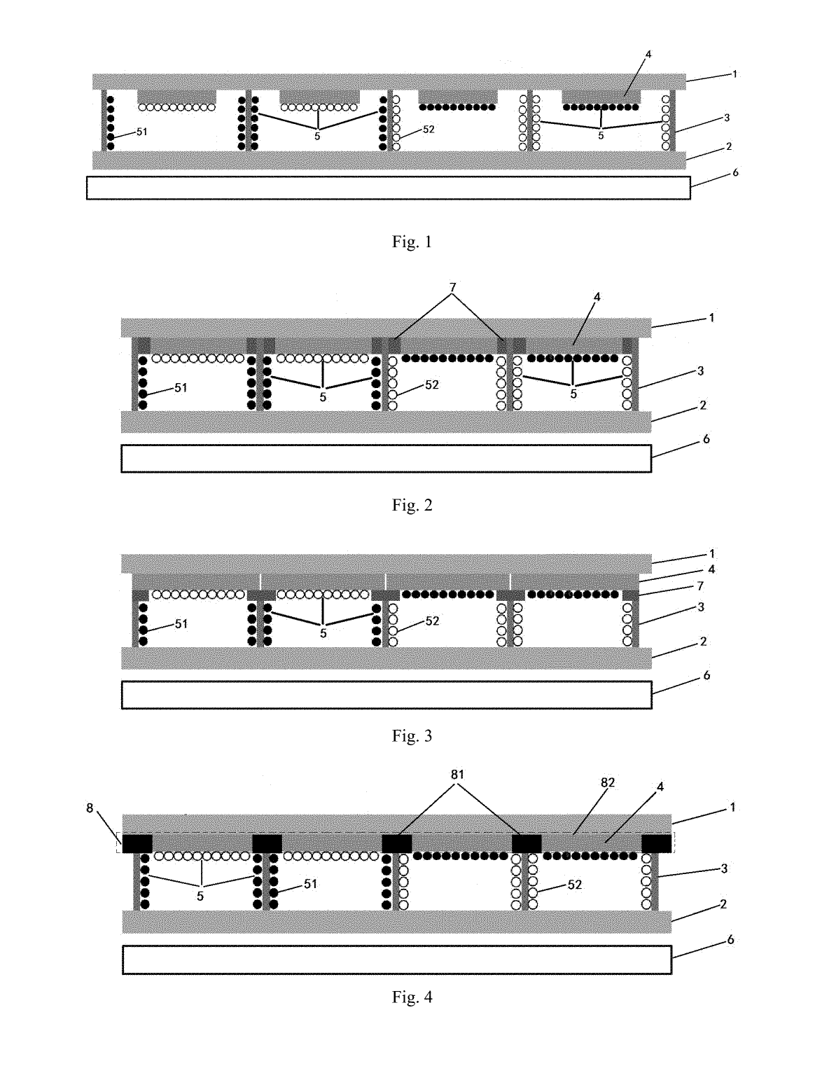

In order to solve the problem in the related art that the electronic paper cannot normally display an image in an environment with relatively weaker light or in a dark environment, an arrangement of the present disclosure provides an electronic paper, referring to FIGS. 1-3.

The electronic paper mainly includes an upper substrate 1, a lower substrate 2, a common electrode 3, a pixel electrode 4, charged particles 5 configured to constitute a displayed image, and an additionally disposed backlight source 6. The upper substrate 1 and the lower substrate 2 are disposed opposite to each other, and are parallel to each other. Both of the upper substrate and the lower substrate are transparent.

The pixel electrode 4 is disposed at a side of the upper substrate 1 close to the lower substrate 2, and is transparent. The pixel electrode 4 can be applies with a positive voltage or a negative voltage. In the present arrangement, a voltage is applied on a plurality of pixel electrodes 4 arranged in an array so that the electrodes attract the charged particles, and hence to constitute a displayed image. Since each of the plurality of pixel electrodes 4 is connected with an independent, voltage controlling unit, the voltage applied on each of the pixel electrodes 4 can be independently controlled.

The common electrode 3 is perpendicular to both of the upper substrate 1 and the lower substrate 2, and is disposed between the upper substrate 1 and the lower substrate 2. The common electrode 3 is distributed to surround the pixel electrode 4 in the electronic paper. The common electrode 3 can have a sheet-like shape or a cylinder shape, and the common electrode 3 can be distributed in a form of net surrounding the pixel electrode 4, without limiting the present disclosure thereto. A voltage applied on the common electrode 3 is a reference voltage which is used as a base voltage of the electronic paper. The electronic paper needs to apply a voltage with a corresponding value on the pixel electrode according to a value of the reference voltage. The reference voltage can be set as 0V, and can also be other voltage values according to actual demands, without particularly limited in the present arrangement.

The present arrangement is described with reference to a black and white electronic paper by way of example. The charged particle 5 in the present arrangement can include a black charged particle 51 and a white semitransparent charged particle 52; the two charged particles 5 have different polarities.

The above-mentioned pixel electrode 4, lower substrate 2, common electrode 3 and charged particle 5 therein constitute a pixel region. Upon applying a voltage on the pixel electrode 4, an electric field is generated between the pixel electrode 4 and the common electrode 3, so as to drive the charged particle 5 to move in the pixel region; in this way, the charged particle 5 with a corresponding polarity forms a color lump on the pixel electrode 4, and the remaining charged particle 5 is attached onto the upright, common electrode 3. For example, when the black charged particle 51 carries a positive charge and the white semitransparent charged particle 52 carries a negative charge, applying a positive voltage on the pixel electrode 4 in the pixel region allows the white semitransparent charged particle 52 to be attached onto the pixel electrode 4 to form a displayed image in this pixel region, and allows the black charged particle 51 to be attached onto the upright common electrode 3.

The backlight source 6 is disposed at a side of the lower substrate 2 far away from the upper substrate 1. When light of the backlight source 6 is irradiated towards the upper substrate 1 from the lower substrate 2, the charged particle 5 attached on the common electrode 3 will not completely block the light of the backlight source 6 which can be directly irradiated onto the charged particle 5 attached on the pixel electrode 4, so as to enhance a display brightness of the white semitransparent charged particle 52 of the charged particle 5, and hence to enhance a display contrast between the two types of charged particles, thereby allowing the electronic paper to clearly display an image constituted by the charged particle 5 on the pixel electrode 4.

As illustrated in FIG. 1, the pixel electrode 4 is fixed at a lower surface of the upper substrate 1 to prevent the pixel electrode 4 from moving and misplacing. The fixing can be achieved by the way of sticking the pixel electrode 4 onto the lower surface of the upper substrate 1; or by setting a transparent slot below the lower surface of the upper substrate 1 according to a distribution of the pixel electrode 4 and then disposing the pixel electrode 4 in the slot. The fixing manner of the pixel electrode 4 is not particularly limited in the present arrangement. The common electrode 3 has one end fixed on the upper substrate 1 and the other end fixed on the lower substrate 2 to prevent the common electrode 3 from moving and misplacing. The fixing can be achieved by the way of sticking the common electrode 3 onto at least one of the upper substrate 1 and the lower substrate 2; or by allowing the common electrode 3 to get stuck between the upper substrate 1 and the lower substrate 2. The fixing manner of the common electrode 3 is not particularly limited in the present arrangement. The pixel electrode 4 and the common electrode 3 are insulated from each other. By way of example, as illustrated in FIG. 2, a certain gap can be reserved between the pixel electrode 4 and the common electrode 3 so as to keep insulation there-between. Optimally, an insulator 7 can also be filled in the gap to ensure a good insulating effect between the two electrodes even when the gap is not large enough.

As illustrated in FIG. 3, all the pixel electrodes 4 are fixed on the lower surface of the upper substrate 1 in a form of a pixel electrode layer, while the common electrode 3 is perpendicular to the lower substrate 2 and is disposed between the pixel electrode 4 and the lower substrate 2, with an end of the common electrode 3 fixed on the lower substrate 2. A certain gap is reserved between the pixel electrode 4 and the common electrode 3, and an insulator 7 can be filled in the gap. The insulator 7 can be consisted of any material with insulating property.

It can be seen from the above structural description of the electronic paper provided by the arrangement of the present disclosure that, in order to allow the electronic paper not to rely only on the reflected light but also achieve imaging in a transmittance mode, a backlight source 6 is additionally disposed at a side of the lower substrate 2 of the electronic paper far away from the upper substrate 1 to emit light towards the upper substrate 1. The arrangement of the present disclosure is to vertically dispose the common electrode 3 of the electronic paper between the upper substrate 1 and the lower substrate 2, so that when an image is formed on the electronic paper, a distribution location of the charged particle 5 attached on the common electrode 3 will not be completely overlapped with a location on the lower substrate 2 corresponding to the pixel electrode 4 because the common electrode 3 is perpendicular to the pixel electrode 4; in this way, the light of the backlight source is capable of irradiating onto the pixel electrode 4 without blocking, so as to enhance a display brightness of an area without the charged particle or an area attached with the white semitransparent charged particle 52 on the pixel electrode 4, thereby increasing the display contrast between black and white charged particles. Therefore, when the electronic paper is in an environment with relatively weaker light or in a dark environment, it can normally display an image by utilizing the backlight source 6 which can increase the display brightness of the image.

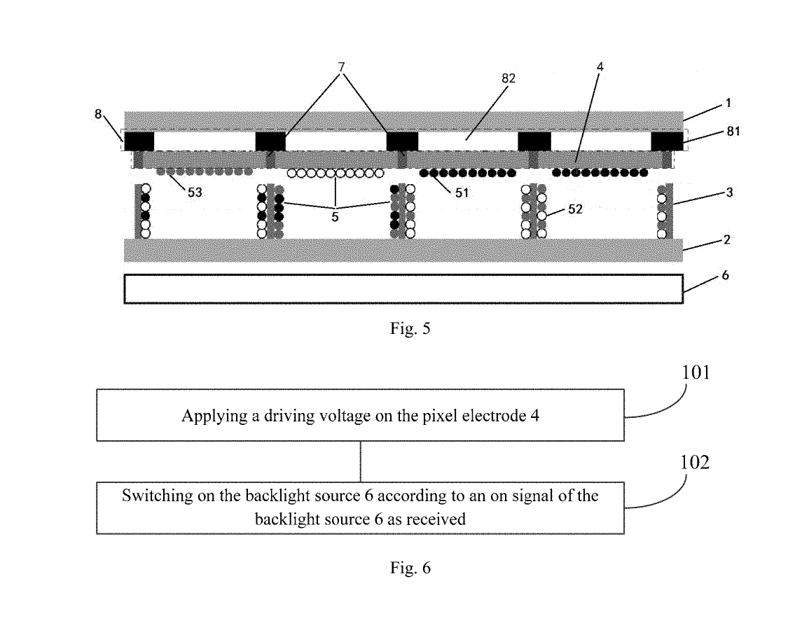

Another arrangement of the present disclosure provides an electronic paper, referring to FIGS. 4-5.

The electronic paper mainly includes an upper substrate 1, a lower substrate 2, a common electrode 3, a pixel electrode 4, charged particles 5, a backlight source 6, a black matrix layer 8 and a light source switch (not illustrated). The upper substrate 1 and the lower substrate 2 are disposed opposite to each other, and both are transparent.

The black matrix layer 8 is disposed between the upper substrate and the pixel electrode. The black matrix layer 8 includes a plurality of black regions 81 and a plurality of hollowed-out locations 82. The black regions 81 are distributed in a form of net in the black matrix layer 8 to surround the hollowed-out locations 82, while the hollowed-out locations 82 are distributed in the black matrix layer 8 in a form of array.

The common electrode 3 is disposed between the black regions 81 of the black matrix layer 8 and the lower substrate 2 so that the black regions 81 completely block the common electrode 3. Since the black regions 81 are distributed in a form of net, the common electrode 3 corresponding to the black regions 81 is distributed in a form of net between the upper substrate 1 and the lower substrate 2. By way of example, in a horizontal direction parallel to the lower substrate 2, the common electrode 3 is corresponding to the black regions 81 of the black matrix layer 8, disposed between the black matrix layer 8 and the lower substrate 2, and is distributed in a form of net. In the horizontal direction, the common electrode 3 is not limited to be continuously distributed or discontinuously distributed. Moreover, a distribution manner of the common electrode 3 in a direction perpendicular to the lower substrate 2 is not limited, either; it can be a continuous and integrally formed electrode, like the common electrode as illustrated in FIGS. 1-5 where the common electrode is continuous and unbroken between the black matrix layer 8 and the lower substrate 2; it can also be an electrode consisted of multiple segments discontinuously distributed, with a certain gap between adjacent segments, so that the common electrode 3 is formed to have a multi-layered structure parallel to the lower substrate 2; moreover, the gap between layers of the common electrode 3 can be configured for wirings of a control circuit or configured to additionally receive related component(s) therein.

The pixel electrode 4 is transparent, and is disposed correspondingly to the hollowed-out location 82 of the black matrix layer 8. The pixel electrode 4, the lower substrate 2, the common electrode 3 and the charged particle 5 constitute a pixel region. The correspondence between the pixel electrode 4 and the hollowed-out location 82 is not limited to a one-to-one correspondence or a multi-to-one correspondence. The electronic paper can apply voltages having different polarities and different magnitudes, respectively, on the pixel electrodes 4.

The common electrode 3 and the pixel electrode 4 are insulated from each other. The common electrode 3 can be arranged in a manner as illustrated in FIG. 4 where the common electrode 3 is disposed below the black region 81 and is fixed between the black region 81 and the lower substrate 2; the common electrode 3 can also be arranged in a manner as illustrated in FIG. 5 where the common electrode 3 is disposed below the black region 81 and has a gap with the black region 81. The pixel electrode 4 can be arranged in a manner as illustrated in FIG. 4 where the pixel electrode 4 is disposed in the hollowed-out location 82; the pixel electrode 4 can also be arranged in a manner as illustrated in FIG. 5 where a pixel electrode layer is disposed below the hollowed-out location 82 and the pixel electrode 4 is disposed in the pixel electrode layer, with an insulator 7 disposed between adjacent pixel electrodes 4, and an alignment connection between the pixel electrode layer and the black matrix layer 8 so that the hollowed-out locations 82 can be corresponding to respective locations of the pixel electrodes 4. The above-mentioned two arrangement manners of the common electrode 3 and two arrangement manners of the pixel electrode 4 can be combined in any manner to form an internal structure of the electronic paper.

The charged particle 5 is filled between the pixel electrode 4 and the lower substrate 2. In the present arrangement, the charged particle 5 can be a combination of two types of colored, charged particles with different polarities and a same driving voltage, or a combination of at least two types of colored, charged particles with a same polarity and different driving voltages, or a combination of at least two types of colored, charged particles with different polarities and different driving voltages. For example, the charged particle 5 includes a black charged particle 51 and a white semitransparent charged particle 52; wherein the black charged particle 51 carries a positive charge and has a driving voltage of 4V, the white semitransparent charged particle 52 carries a negative charge and has a driving voltage of 4V, and wherein the driving voltage is not particularly limited herein. Alternatively, as illustrate in FIG. 5, the charged particle 5 includes a black charged particle 51, a white semitransparent charged particle 52, and a red charged particle 53; wherein the black charged particle 51 carries a positive charge and has a driving voltage of 4V, the white semitransparent charged particle 52 carries a negative charge and has a driving voltage of 3V, and the red charged particle 53 carries a positive charge and has a driving voltage of 2V; or, these three colors of charged particles 5 each carry a positive charge, with the black charged particle 51 having a driving voltage of 4V, the white semitransparent charged particle 52 having a driving voltage of 3V, and the red charged particle 53 having a driving voltage of 2V. That is to say, the electronic paper according to the present disclosure can be a black and white electronic paper, and can also be a colored electronic paper, depending on the color of the charged particle. Although the above is described with reference to a black and white electronic paper and a tricolored electronic paper, it should be appreciated that the present disclosure is not limited thereto.

Upon applying a driving voltage on the pixel electrode 4, an electric field is generated between the pixel electrode 4 and the common electrode 3 so as to drive the charged particle 5 to move in the pixel region; in this way, the charged particle 5 with a corresponding polarity forms a color lump on the pixel electrode 4, and the remaining charged particle 5 is attached onto the common electrode 3. Upon switching on the backlight source, the light can be directly irradiated onto the pixel electrode 4 to increase the display contrast between nontransparent charged particle and semitransparent charged particle, so as to allow the electronic paper to clearly display an image. Moreover, the black region 81 blocks a projection of the charged particle 5 on the common electrode 3, so that the projection of the charged particle 5 attached on the common electrode 3 will not pass through the upper substrate 1 to be displayed on the electronic paper, which prevents from any noise occurred on the electronic paper.

Additionally, the electronic paper is also provided with a light source switch configured to control an on-off state of the backlight source 6 and adjust a brightness of backlight. The light source switch can be configured as a mechanical switch or an inductive switch. The mechanical switch can be manually triggered by a user to switch on the backlight source 6, while the inductive switch can be automatically triggered according to a light intensity of external ambient light to switch on the backlight source 6.

It should be noted that, the electronic paper according to the present arrangement can be used in both of a transmittance mode and a reflection mode. This is achieved by an arrangement of a common electrode perpendicular to the substrate to make the particle attached on the common electrode invisible so that backlight can be irradiated onto the white semitransparent particle attached on the pixel electrode.

In order to allow the electronic paper to achieve imaging not only relying on reflected light, the arrangement of the present disclosure additionally dispose a backlight source 6 at a side of the lower substrate 2 far away from the upper substrate 1 and also dispose a light source switch correspondingly so that the backlight source 6 can be controlled to emit backlight with adjustable brightness by a user manually operating the light source switch or by the light source switch automatically. In order to prevent the charged particle 5 attached on the common electrode 3 from affecting the backlight irradiating towards the pixel electrode 4, the common electrode 3 is disposed to be perpendicular to the lower substrate 2, so that the charged particle attached on the common electrode 3 will not block the backlight to be irradiated on the pixel electrode when the electronic paper displays an image, thereby increasing a display brightness of an area without the charged particle or an area attached with the white semitransparent charged particle 52 on the pixel electrode 4, and hence increasing the display contrast between transparent charged particle and nontransparent charged particle. Therefore, when the electronic paper is in an environment with relatively weaker light or in a dark environment, it can normally display an image by utilizing the backlight source 6 which can increase the display brightness of the image. At the same time, in order to prevent a projection of the charged particle 5 attached on the common electrode 3 from generating a noise on the electronic paper when the backlight is irradiated on the common electrode 3, the common electrode 3 is disposed between the black region 81 of the black matrix layer 8 and the lower substrate 2 so that the black region 81 can block the projection of the charged particle 5 attached on the common electrode 3, thereby preventing the electronic paper from displaying a noise when using the backlight source 6 for image display.

Based on the arrangements above, the arrangement of the present disclosure provides a display method of an electronic paper. Referring to FIG. 6, a method of displaying an image by using the electronic paper in the arrangements above includes the following.

In S101, applying a driving voltage on the pixel electrode 4.

A corresponding charged particle 5 is driven to be attached onto the pixel electrode 4 from the common electrode 3.

When displaying different images, a same pixel region on the electronic paper can present different colors. The color presented on the pixel region is determined by a color of the charged particle 5 on the pixel electrode 4, and charged particles 5 of different colors have different driving voltages. As a result, the electronic paper is required to provide the pixel electrode 4 with a driving voltage of a corresponding charged particle 5 according to a color to be displayed on the pixel region. That is to say, the above-mentioned driving method can be applied to drive both of a black and white electronic paper and a colored electronic paper. Upon applying a driving voltage on the pixel electrode 4, an electric field is generated between the pixel electrode 4 and the common electrode 3 to drive the charged particle 5 to move in the electric field and finally be attached onto a corresponding electrode, so as to allow this pixel region to present a corresponding color. The driving voltage applied on different pixel electrodes 4 is varied, thus different pixel regions display different colors, and a complete, displayed image is constituted on the electronic paper based on the colors of all the pixel regions.

In S102, switching on the backlight source 6 according to an on signal of the backlight source 6 as received.

In an environment with relatively weaker light or in a dark environment, the backlight source 6 can be switched on by triggering an on signal. The on signal can be trigger manually for output by a user, and can also be automatically triggered for output according to external ambient light. After receiving the on signal, the electronic paper can switch on the backlight source 6 disposed at the side of the lower substrate 2 far away from the upper substrate 1 to allow the backlight to be irradiated onto the pixel electrode 4, so as to increase the display contrast between nontransparent charged particle and semitransparent charged particle; in this way, an image can be clearly displayed on the electronic paper.

The display method of electronic paper provided by the arrangement of the present disclosure applies different driving voltages onto different pixel electrodes 4, respectively, according to a color to be displayed in each of the pixel regions, so as to allow the pixel region to display a corresponding color; as a result, a complete image can be displayed on the electronic paper. Furthermore, the display method can switch on the backlight source 6 of the electronic paper by receiving a manually triggered or automatically triggered on signal, to allow the backlight to be irradiated on the charged particle 5 of the pixel electrode 4 to increase the display contrast between nontransparent charged particle and semitransparent charged particle; in this way, the electronic paper can clearly display an image by using the backlight even in an environment with relatively weaker light or in a dark environment.

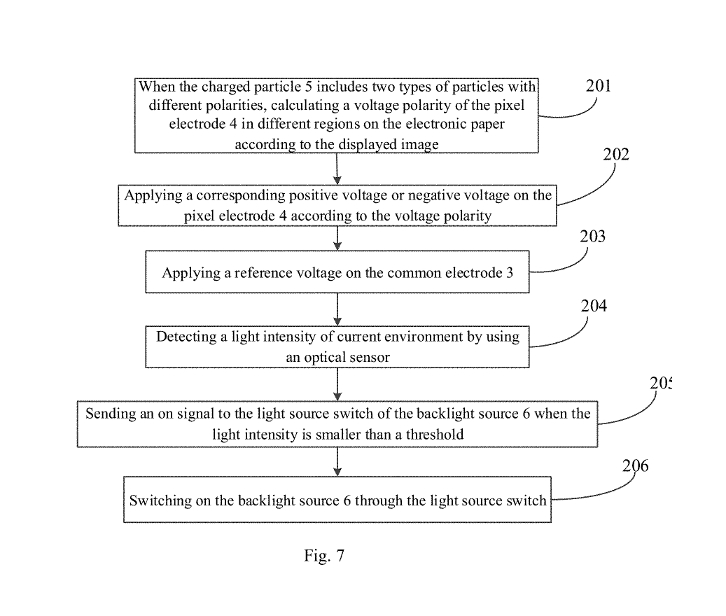

Based on the arrangements above, the arrangement of the present disclosure provides another display method of an electronic paper. Referring to FIG. 7, a method of displaying an image by using the electronic paper in the arrangements above includes the following.

In S201, in the case where the charged particle 5 includes two types of particles with different polarities, calculating a voltage polarity of the pixel electrode 4 in different regions on the electronic paper according to the displayed image.

If the electronic paper includes only two types of particles 5 with opposite polarities, then the charged particle 5 can be accurately driven to move in the pixel region just by applying a driving voltage with a corresponding polarity. A specified color of different pixel regions is obtained according to the image to be displayed, and the polarity of the charged particle to be attached onto the pixel electrode 4 in the pixel region is determined according to the specified color.

In S202, applying a corresponding positive voltage or negative voltage on the pixel electrode 4 according to the voltage polarity.

For example, the charged particle 5 of the pixel region includes a black charged particle 51 and a white semitransparent charged particle 52, wherein the white semitransparent charged particle 52 carries a negative charge and the black charged particle 51 carries a positive charge. If the pixel region needs to display white color, then applying a positive voltage on the pixel electrode 4 to drive the white semitransparent charged particle 52 to move towards the pixel electrode 4 and finally be attached on the pixel electrode 4; and to drive the black charged particle 51 to move towards the common electrode 3 and finally be attached on the common electrode 3; as a result, the pixel region presents white color by attaching the white semitransparent charged particle 52 onto the pixel electrode 4. Different pixel electrodes 4 are applied with driving voltages having different polarities so as to display different colors; as a result, the displayed image is constituted according to the colors displayed on all the pixel regions.

In S203, applying a reference voltage on the common electrode 3.

The common electrode 3 has to be continuously powered during the entire usage of the electronic paper while the voltage of the common electrode 3 is a reference voltage, thus in order to save a power consumption of the electronic paper, the common electrode 3 can be applied with the reference voltage so as not to consume any electric power during usage and to extend the service life of the electronic paper. The reference voltage can be, for example, 0V.

In S204, detecting a light intensity of current environment by using an optical sensor.

In order to allow the electronic paper to automatically switch on the backlight source 6 to adjust the display brightness and to normally display the image in an environment with relatively weaker light or a dark environment, an optical sensor needs to be utilized to monitor the brightness of the electronic paper in real time. When it's detected that the light intensity of current external ambient light is not sufficient to allow the electronic paper to normally display an image, an on signal of the backlight source 6 is triggered so as to switch on the backlight source 6 to increase the brightness of the electronic paper.

In S205, sending an on signal to the light source switch of the backlight source 6 when the light intensity is smaller than a threshold.

In order to correctly determine whether the light intensity of current external ambient light allows the electronic paper to normally display an image, it has to preset a threshold of light intensity to be received by the electronic paper when normally displaying an image according to actual conditions. If the light intensity of current ambient light is smaller than the threshold, then it's determined that the electronic paper cannot normally display an image through reflected light at this moment and an on signal needs to be triggered to switch on the backlight source 6; and if the light intensity of ambient light received by electronic screen is greater than or equal to the threshold, then it's determined that the electronic paper can normally display an image through reflected light at this moment and the backlight source 6 is unnecessary to be switched on. Optionally, upon determining that an on signal needs to be triggered to switch on the backlight source 6, sending the on signal to the light source switch of the backlight source 6 to switch on the backlight source 6 through the light source switch.

In S206, switching on the backlight source 6 through the light source switch.

Upon receiving the on signal by the light source switch, switching on the backlight source 6 according to the on signal to control the backlight emitted by the backlight source 6 to be irradiated onto the pixel electrode 4 to increase the display contrast between semitransparent charged particle and nontransparent charged particle; in this way, the electronic paper can adjust the display brightness through the backlight to achieve normally displaying an image when it cannot normally display an image by reflected ambient light.

The display method of electronic paper provided by the arrangement of the present disclosure can determine the polarity of the driving voltage to be applied on the pixel electrode 4 according to a color of an image to be displayed, and can apply a reference voltage on the common electrode 4 in order to reduce the power consumption of the electronic paper. By applying voltages having different polarities on different pixel electrodes 4 respectively, charged particles 5 with a corresponding color is controlled to be attached onto the pixel electrode 4, so that different pixel regions can display different colors; as a result, a specified image can be displayed on the electronic paper. Furthermore, the display method can automatically trigger an on signal of the backlight source 6 through the optical sensor, and can switch on the backlight source 6 of the electronic paper through the light source switch, so as to allow the electronic paper to adjust the display brightness through the backlight to achieve the objective of normally displaying an image when it cannot normally display an image by the reflected ambient light.

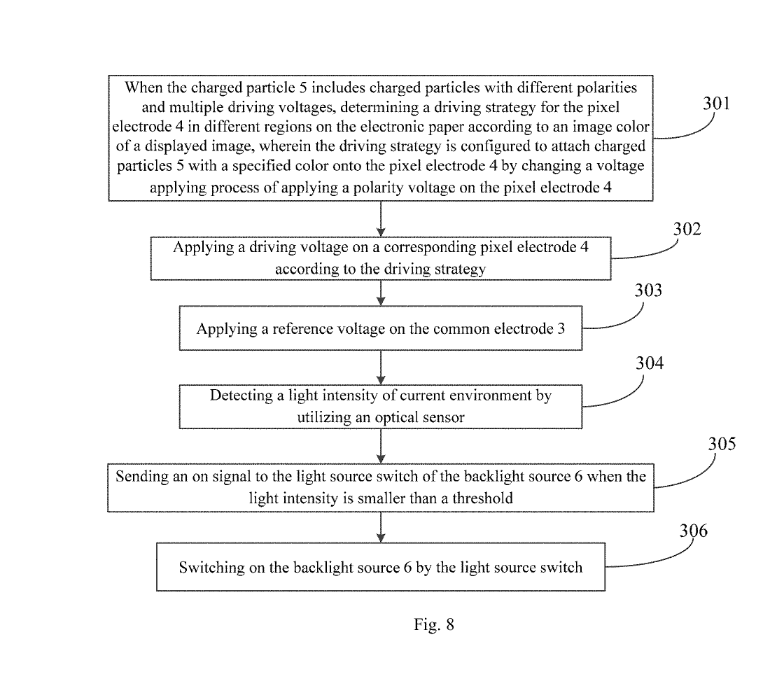

The arrangement of the present disclosure further provides another display method of an electronic paper. Referring to FIG. 8, a method of displaying an image by using the electronic paper in the arrangements above includes the following.

In S301, in the case where the charged particle 5 includes charged particles with different polarities and multiple driving voltages, determining a driving strategy for the pixel electrode 4 in different regions on the electronic paper according to an image color of a displayed image, wherein the driving strategy is configured to attach charged particles 5 with a specified color onto the pixel electrode 4 by changing a voltage applying process of applying a polarity voltage on the pixel electrode 4.

The driving strategy is obtained, in advance, by calculating, according to a polarity, a driving voltage and a color of the charged particle 5. When the electronic paper includes charged particles with more than two colors and when these charged particles with different colors have different polarities and different driving voltages, it has to determine the driving strategy to be used according to the color to be currently displayed on the pixel region, and then correctly drive charged particles with the specified color to be attached onto the pixel electrode 4 according to the driving strategy, so as to allow the pixel region to display the specified color. Moreover, when the pixel region changes the color to be displayed, the driving strategy is automatically changed correspondingly, so as to change the color of the charged particle 4 attached on the pixel electrode 4.

In S302, applying a driving voltage on a corresponding pixel electrode 4 according to the driving strategy.

For a colored electronic paper, by way of example, it includes a black charged particle 51, a white semitransparent charged particle 52, and a red charged particle 53; wherein the white semitransparent charged particle 52 carries a negative charge and has a driving voltage of 3V, the red charged particle 53 carries a positive charge and has a driving voltage of 2V, and the black charged particle 51 carries a positive charge and has a driving voltage of 4V. If the pixel region is to display white color, then applying a driving voltage of +5V on the pixel electrode 4 according to the corresponding driving strategy, which driving voltage is greater than that of all the charged particles and can drive all the charged particles 5 to move; the white semitransparent charged particle 52 is driven to be attached onto the pixel electrode 4 to form a white lump, while the remaining black charged particle 51 and the red charged particle 53 are driven to be attached onto the common electrode 4. When the color to be displayed in the pixel region is changed to red, then applying a driving voltage of −3V on the pixel electrode 4 according to the corresponding driving strategy, which driving voltage can drive the white semitransparent charged particle 52 and the red charged particle 53 to move, allowing the red charged particle 53 to be attached onto the pixel electrode 4 to form a red lump and allowing the white semitransparent charged particle 52 to be attached onto the common electrode 4, while maintaining a location of the remaining black charged particle 51 unchanged because the currently applied voltage is smaller than the driving voltage of the black charged particle 51; that is, the black charged particle 51 is still attached on the common electrode 3. When the color to be displayed in the pixel region is changed to black, then firstly applying a driving voltage of −4V on the pixel electrode 4 according to the corresponding driving strategy, to drive all the charged particles 5 to move, allowing both of the red charged particle 53 and the black charged particle 51 to be attached onto the pixel electrode 4 and allowing the white semitransparent charged particle 52 to be attached onto the common electrode 4; subsequently, applying a driving voltage of +2V on the pixel electrode 4, which driving voltage can only drive the red charged particle 53 to move, allowing the red charged particle 53 to be attached onto the common electrode 3, while maintaining a location of the white semitransparent charged particle 52 and hence a location of the black charged particle 51 unchanged because the currently applied voltage is smaller than the driving voltage of the white semitransparent charged particle 52 and the black charged particle 51; that is, the white semitransparent charged particle 52 is still attached on the common electrode 3 and the black charged particle 51 is still attached on the pixel electrode 4; at this time, the pixel electrode 4 is only attached with the black charged particle 51 which forms a black lump thereon.

In S303, applying a reference voltage on the common electrode 3.

In S304, detecting a light intensity of current environment by utilizing an optical sensor.

In S305, sending an on signal to the light source switch of the backlight source 6 when the light intensity is smaller than a threshold.

In S306, switching on the backlight source 6 by the light source switch.

The implementation of the above-mentioned 303-306 is as same as the implementation of the above-mentioned 203-206, without repeating herein.

The display method of electronic paper provided by the arrangement of the present disclosure, in the case where the electronic paper includes colored, charged particles 5 with different polarities and multiple driving voltages, can determine a driving strategy for the pixel electrode according to a polarity and a driving voltage of the charged particle as well as a color to be displayed in the pixel electrode, and then apply a driving voltage on the pixel electrode 4 by utilizing the driving strategy, so as to control charged particles 4 with a specified color to be attached onto the pixel electrode 4. Further, in the case where the electronic paper includes charged particles of multiple colors, the display method applies different driving voltages on different pixel electrodes 4, respectively, according to corresponding driving strategies, so as to control each of the pixel regions to display the specified color, and hence to display a specified image on the electronic paper. In order to reduce the power consumption of the electronic paper, the arrangement of the present disclosure applies a reference voltage on the common electrode 3. The reference voltage can be, for example, 0V. The arrangement of the present disclosure automatically switches on the backlight source 6 through the optical sensor and the light source switch, so as to adjust the display brightness through the backlight to achieve the objective of normally displaying an image when the electronic paper cannot normally display an image through the reflected light.

Based on the arrangements above, the arrangement of the present disclosure provides a display device. The display device is provided with the electronic paper described herein, and thus can increase the display brightness of the image thereof by utilizing the backlight, so as to achieve the objective of still capable of normally displaying an image even in an environment with relatively weaker light or in a dark environment. The display device can be an e-book reader, an advertising display board, an electronic indicator board, an intelligent terminal with displaying function and the like. A display mode of the display device is not particularly limited in the present arrangement.

Descriptions of the preceding arrangements focus differently. A portion that is not particularly described in one arrangement can refer to related explanation in other arrangement(s).

It should be understood that, cross-reference can be made for related features of the above-mentioned device. Additionally, terms such as “first” and “second” used in the preceding arrangements are used for distinguishing these arrangements one from another but not for implying any one superior to the other(s).

Plenty of details are set forth in the specification provided herein. However, it should be appreciated that, the arrangements of the present disclosure can be practiced without these details. In some arrangements, well-known structure(s) and technology are omitted with detailed explanation(s) so as not to obscure the understanding of the present specification.

Those skilled in the art should be appreciated that, component(s) in the device of one arrangement can be adaptively modified to be disposed in one or more device different from this arrangement. Multiple components in the arrangement(s) can be combined into a single one, and additionally can be divided into a plurality of sub-components. All of the features disclosed in this specification (including any accompanying claims, abstract and drawings), and all of the components of any device so disclosed, may be combined in any combination, except combinations where at least some of such features are mutually exclusive. Each of the features disclosed in this specification (including any accompanying claims, abstract and drawings) can be replaced by any substituted feature(s) providing the same, equivalent or similar objective(s), unless otherwise definitely stated.

Additionally, those skilled in the art should be appreciated that, although some of described arrangements herein include certain feature(s) included in other arrangement(s) rather than other feature(s), a combination of features from different arrangements is intended to be fallen within the scope of the present disclosure and constitutes different arrangement(s). For example, in the appended claims below, any one of the arrangement(s) to be claimed can be used in any combination form. Arrangement(s) of each component in the present disclosure can be implemented with hardware, or a combination thereof.

It should be noted that, the arrangements above are for explanation of the present disclosure but are not limitative, and alternative arrangement(s) can be designed by those skilled in the art without departing from the scope of the appended claims. In the claims, any reference mark located within a bracket should not be considered as constituting any limitation to the claims. The word “comprise” is not intended to exclude the presence of any component or part not listed in the claims. The word “a” or “an” appeared in front of a component or part is not intended to exclude the presence of a plurality of such components or parts. The present disclosure may be implemented with the aid of a device including several different components. In the claim(s) listing several components, several of these components can be embodied with a same component item. The word “first”, “second” or “third” as used is not intended to imply any order but may be interpreted as a name.

The above are merely illustrative arrangements of the present disclosure but not any limitation to the present disclosure in any form. Any simple modification, equivalent change and decoration in accordance with the technical inspirit(s) of the present disclosure still belong to the scope of the technical solution(s) of the present disclosure.

What is claimed is:

1. An electronic paper, comprising:
an upper substrate;
a lower substrate, the upper substrate and the lower substrate being disposed opposite to each other;
a pixel electrode;
a common electrode;
charged particles; and
a backlight source disposed at a side of the lower substrate far away from the upper substrate, wherein the pixel electrode is parallel to the upper substrate and is disposed at a side of the upper substrate close to the lower substrate, and the common electrode is perpendicular to the lower substrate and is disposed between the upper substrate and the lower substrate.

2. The electronic paper according to claim 1, further comprising a black matrix layer disposed between the upper substrate and the pixel electrode, wherein the common electrode is disposed between a black region of the black matrix layer and the lower substrate.

3. The electronic paper according to claim 2, wherein the pixel electrode is disposed at a hollowed-out location of the black matrix layer, and the pixel electrode is connected with an independent, voltage controlling unit.

4. The electronic paper according to claim 3, wherein the pixel electrode is arranged in an array.

5. The electronic paper according to claim 2, wherein in a direction parallel to the lower substrate, the common electrode is corresponding to the black matrix layer, disposed between the black matrix layer and the lower substrate, and is distributed in a form of net.

6. The electronic paper according to claim 1, wherein the pixel electrode and the common electrode are insulated from each other, and are provided with a gap there-between.

7. The electronic paper according to claim 6, wherein the gap between the pixel electrode and the common electrode is filled with an insulator.

8. The electronic paper according to claim 1, wherein the electronic paper comprises:
a light source switch, configured to control an on-off state of the backlight source and adjust a brightness of backlight.

9. The electronic paper according to claim 8, further comprising an optical sensor, when the optical sensor detects a light intensity of ambient light being smaller than a threshold value, an on signal is sent to the light source switch so that the light source switch switches on the backlight source.

10. The electronic paper according to claim 1, wherein the charged particles are filled between the pixel electrode and the lower substrate, and comprises:
a combination of two types of colored, charged particles with different polarities and a same driving voltage; or
a combination of at least two types of colored, charged particles with a same polarity and different driving voltages; or
a combination of at least two types of colored, charged particles with different polarities and different driving voltages.

11. A method of driving the electronic paper according to claim 1, comprising:
applying a driving voltage on the pixel electrode according to an image signal to be displayed, to allow a corresponding, charged particle to be attached onto the pixel electrode from the common electrode; and
switching on the backlight source according to an on signal of the backlight source as received.

12. The method according to claim 11, wherein switching on the backlight source according to an on signal of the backlight source as received comprises:
detecting a light intensity of current environment by utilizing an optical sensor;
sending an on signal to a light source switch of the backlight source upon the light intensity being smaller than a threshold; and
switching on the backlight source by the light source switch.

13. The method according to claim 11, wherein the charged particle comprises two types of particles with different polarities, applying a driving voltage on the pixel electrode comprises:
determining a voltage polarity of the pixel electrode in different regions of the electronic paper according to an image signal to be displayed;
applying a corresponding, positive voltage or negative voltage on the pixel electrode according to the voltage polarity; and
applying a reference voltage on the common electrode.

14. The method according to claim 11, wherein the charged particle comprises colored charged particles with different polarities and multiple driving voltages, applying a driving voltage on the pixel electrode comprises:
determining a color to be displayed on different regions of the electronic paper according to an image signal to be displayed, to determine a driving voltage of a corresponding pixel electrode, so as to allow charged particles, with the color to be displayed, to be attached onto the pixel electrode; and
applying a reference voltage on the common electrode.

15. A display device, comprising
an electronic paper, the electronic paper comprising
an upper substrate;
a lower substrate, the upper substrate and the lower substrate being disposed opposite to each other;
a pixel electrode;
a common electrode;
charged particles;
a backlight source disposed at a side of the lower substrate far away from the upper substrate, wherein
the pixel electrode is parallel to the upper substrate and is disposed at a side of the upper substrate close to the lower substrate; and
the common electrode is perpendicular to the lower substrate and is disposed between the upper substrate and the lower substrate.
